(19) United States
(12) Patent Application Publication
(10) Pub. No.: US 2023/0298092 A1
(43) Pub. Date: Sep. 21, 2023

(54) VEHICLE AVAILABILITY USER INTERFACE ELEMENTS FOR AN ONLINE SYSTEM

(71) Applicant: Tekion Corp, Pleasanton, CA (US)

(72) Inventors: Jawahar Prasad, Bangalore (IN); Gaurav Gupta, Chandigarh (IN); Nirmal Sajo Thomas, Thiruvalla (IN)

(21) Appl. No.: 17/696,574

(22) Filed: Mar. 16, 2022

(51) Int. Cl. G06Q 30/06; G06Q 30/02; G07C 5/08

(52) U.S. Cl. CPC G06Q 30/0643; G06Q 30/0201; G07C 5/0816

(57) ABSTRACT

An online system provides users with a vehicle selection interface to select vehicles available on the online system. The vehicle selection interface may include vehicle user interface elements that display information about individual vehicles available on the online system. The vehicle selection interface may display a set of vehicle user interface elements for the user to select. The vehicle selection interface may further include a vehicle availability element. A vehicle availability element describes availability of vehicles in a set of categories. For example, the vehicle availability element may describe the availability of vehicles within different price ranges. The vehicle availability element may indicate trends in vehicle availability on the online system within each category of vehicle. For example, the vehicle availability element may indicate that vehicle availability in a category is likely to decrease based on predictions of increased user selections of vehicles in that category.

### BACKGROUND

An online system may provide products or services for selection by its users. For example, an online system may enable users to select vehicles for offer by the online system. Online systems provide user interfaces to users that allow them to select the products or services that are available on the online system. However, conventionally, online systems simply consider the products or services that they offer when determining what to list in their user interfaces. Conventional online systems typically fail to consider dynamic information in the presentation of products or services to users in user interfaces, such as real-time application usage by users. Accordingly, conventional online systems typically present out-of-date, irrelevant, or incomplete information in their user interfaces.

### SUMMARY

The online system presented herein provides an improved user interface to a user by collecting sensor data describing measurements of vehicles available on the online system and providing an indication of user interest in those vehicles in a vehicle availability element in a vehicle selection interface.

An online system provides users with a vehicle selection interface to select vehicles available on the online system. The vehicle selection interface may include vehicle user interface elements that display information about individual vehicles available on the online system. For example, a vehicle user interface element may include a vehicle's name, make, model, year, mileage, and/or price. The vehicle selection interface may display a set of vehicle user interface elements for the user to select. The vehicle selection interface may further allow a user to filter out vehicles by interacting with filter options of the vehicle selection interface.

The vehicle selection interface may further include a vehicle availability element. A vehicle availability element describes availability of vehicles in a set of categories. For example, the vehicle availability element may describe the availability of vehicles within different price ranges. In some embodiments, the vehicle availability element is a histogram that represents the availability of vehicles in each of a set of categories.

The vehicle availability element may indicate trends in vehicle availability on the online system within each category of vehicle. For example, the vehicle availability element may indicate that vehicle availability in a category is likely to decrease based on predictions of increased user selections of vehicles in that category or based on decreased supply of vehicle in that category. Similarly, the vehicle availability element may indicate to a user when other users of the online system are interested in vehicles in a category. For example, the vehicle availability element may indicate to a user when another user of the online system is viewing a page for a vehicle in a category or when another user is test driving a vehicle.

By providing information about trends in vehicle availability on the online system, a vehicle availability element may ensure that user is fully informed of future availability of vehicles on the online system. The online system may consider specific, dynamic data, such as sensor data from sensors in vehicles, to provide a better understanding to a user of what the true availability of vehicles is on the online system. The online system accomplishes this goal by providing a vehicle availability element in the vehicle selection interface, which provides real-time information on vehicle availability based on user activity data describing user interest in vehicles on the online system.

### BRIEF DESCRIPTION OF THE DRAWINGS

FIG. 1 illustrates an example system environment for an online system, in accordance with some embodiments.

FIGS. 2A-2D illustrate example vehicle selection interfaces, in accordance with some embodiments.

FIG. 3 is a flowchart for a method of determining vehicle availability for an online system, in accordance with some embodiments.

### DETAILED DESCRIPTION

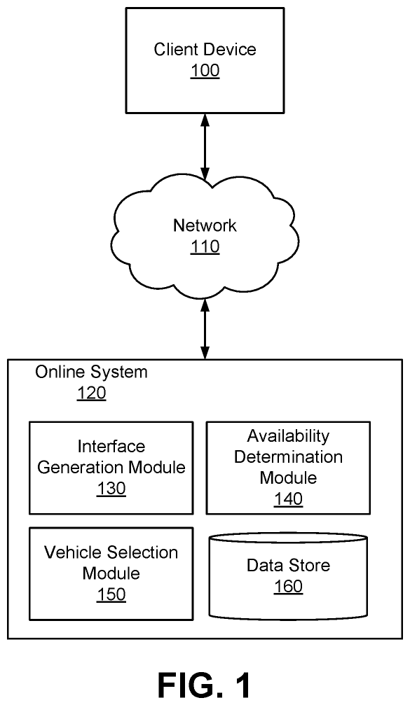

FIG. 1 illustrates an example system environment for an online system, in accordance with some embodiments. The system environment illustrated in FIG. 1 includes a client device 100, a network 110, and an online system 120. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

A user can interact with the online system 120 through a client device 100. The client device 100 can be a personal or mobile computing device, such as a smartphone, a tablet, a laptop computer, or desktop computer. In some embodiments, the client device 100 executes a client application that uses an application programming interface (API) to communicate with the online system 120 through the network 110. The client application may be downloaded from the online system 120 and/or through a web browser of the client device 100.

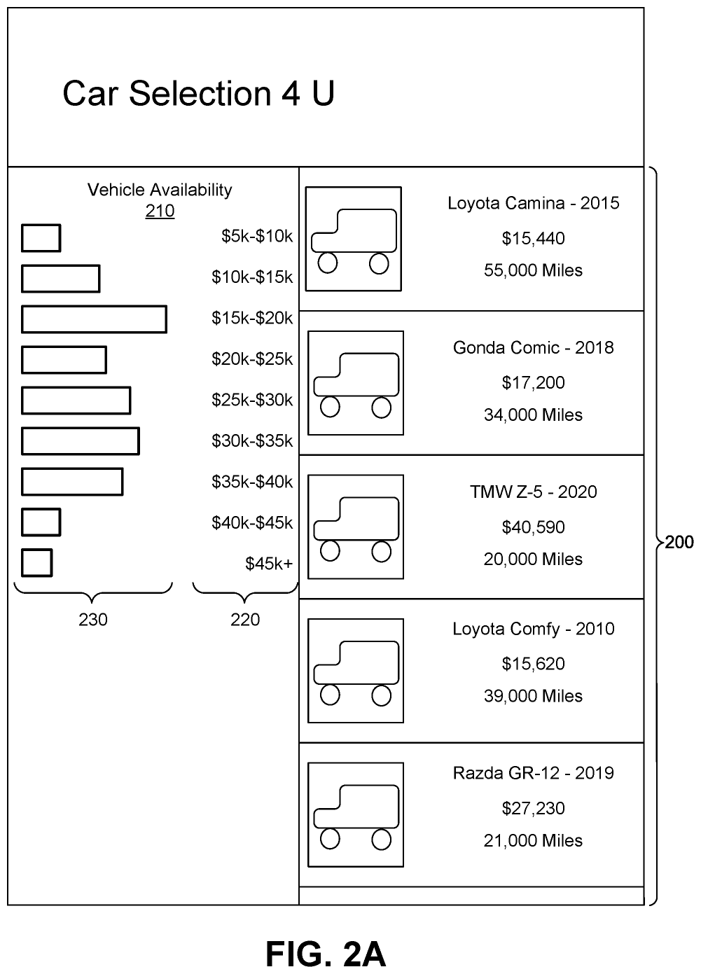

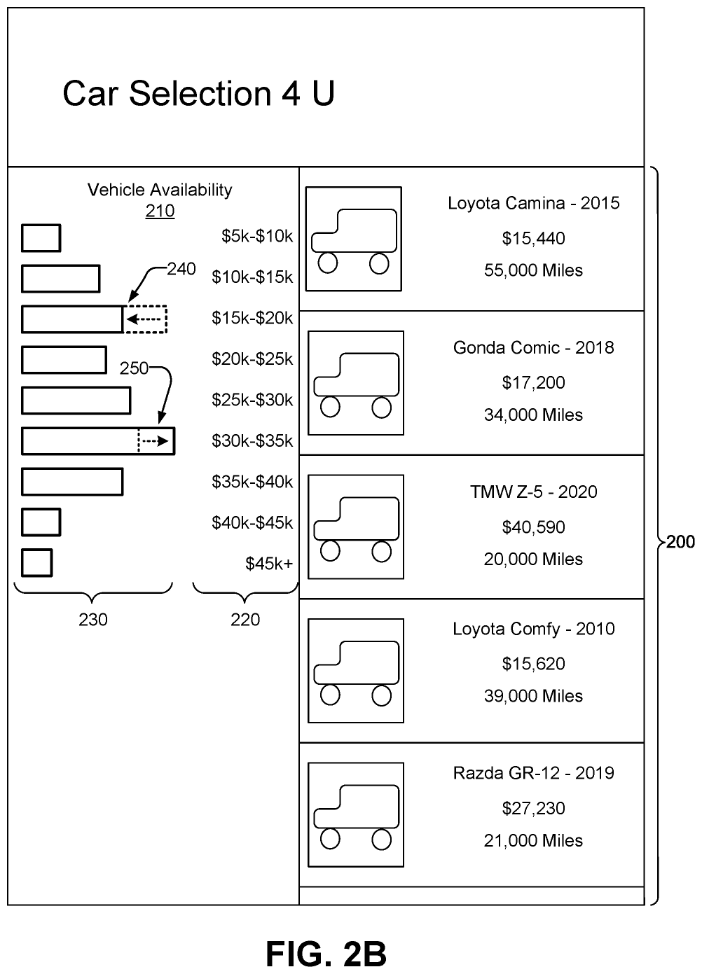

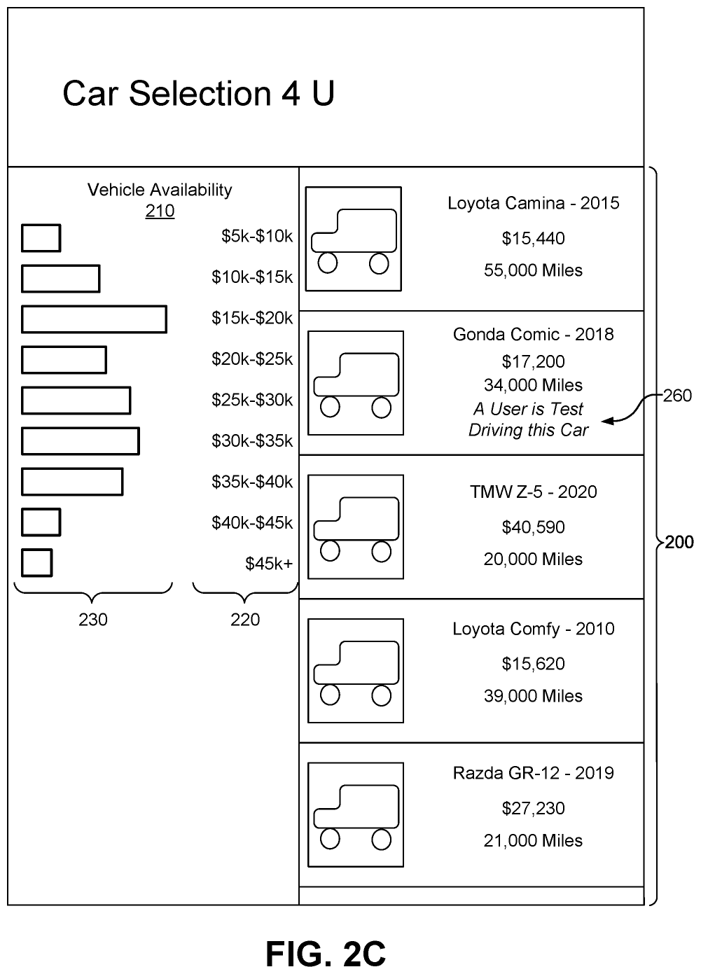

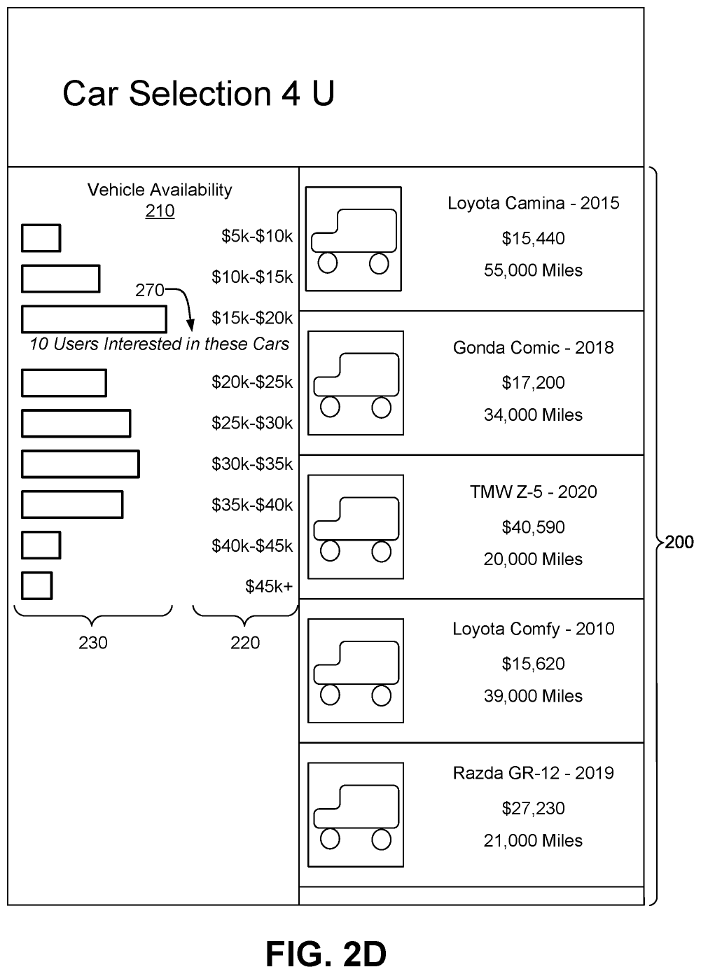

The client device 100 may display a vehicle selection interface to a user. A vehicle selection interface is a user interface that allows the user to select one or more vehicles. For example, a vehicle selection interface may allow a user to select a vehicle to purchase, rent, or borrow from the online system 120. The vehicle selection interface may include vehicle UI elements that display vehicles that are available for selection by the user. Additionally, the vehicle selection interface may further include a vehicle availability element that describes the availability of vehicles in each of a set of categories. Example vehicle selection interfaces are described in more detail below with respect to FIGS. 2A-2D.

The client device 100 can communicate with the online system 120 via the network 110, which may comprise any combination of local area and wide area networks employing wired or wireless communication links. In some embodiments, the network 110 uses standard communications technologies and protocols. For example, the network 110 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 110 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 110 may be represented using any format, such as hypertext markup language (HTML) or extensible markup language (XML). In some embodiments, all or some of the communication links of the network 110 may be encrypted.

FIG. 1 also illustrates an example system architecture of an online system 120, in accordance with some embodiments. The online system 120 illustrated in FIG. 1 includes n interface generation module 130, an availability determination module 140, a vehicle selection module 150, and a data store 160. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

The interface generation module 130 generates user interfaces to display on the user device 100 by the online system 120. For example, the interface generation module 130 may generate interfaces by which a user can view details about vehicles available on the online system 120 and/or by which the user can provide purchasing and/or rental information. The interface generation module 130 also generates vehicle selection interfaces. A vehicle selection interface is a user interface by which a user can select a vehicle. The vehicle selection interface may include one or more vehicle user interface elements. A vehicle user interface element is a user interface element that describes a vehicle that is available for selection on the online system 120. The vehicle user interface element may include information describing the vehicle, such as the make, model, year, mileage, or price of the vehicle. The vehicle selection interface may rank the displayed vehicle user interface elements based on a criterion. For example, the vehicle selection interface may rank the vehicle user interface elements based on their price. In some embodiments, the vehicle selection interface ranks vehicle user interface elements based on relevance scores for the user of the vehicles associated with the vehicle user interface elements. For example, the online system 120 may determine a relevance score for each vehicle associated with each of the vehicle user interface elements based on known information about the user or based on a search query submitted by the user. In some embodiments, the online system 120 uses a machine-learning model to determine a relevance score for each vehicle.

In some embodiments, the interface generation module 130 performs a preliminary filter on which vehicles may be presented in the vehicle selection interface. For example, the interface generation module 130 may determine a location of a user viewing the vehicle selection interface and may limit the vehicles presented as vehicle user interface elements in the vehicle selection interface to those that are available for selection within some threshold area near the user's location.

The vehicle selection interface also includes a vehicle availability element. A vehicle availability element describes the availability of vehicles within a set of categories. The categories may include price ranges, makes, models, mileages, and/or years. In some embodiments, the user can interact with the vehicle availability element to filter which vehicle user interface elements are presented to a user. For example, the user may interact with the vehicle availability element to select a category of the presented set of categories and the vehicle selection interface may update which vehicle user interface elements are presented such that only vehicles within the selected category are presented to the user. In some embodiments, the vehicle availability element includes a slider user interface element that a user can use to filter vehicles. For example, the vehicle availability element may receive a user interaction with a slider interface element that indicates one or more categories that are of interest to the user (e.g., a minimum or maximum price that the user is willing to pay). The vehicle selection interface may then be updated based on the user interaction (e.g., by filtering out vehicles that are outside of the minimum or maximum price set by the user). The vehicle availability element may include a vertical and/or horizontal histogram that illustrates the availability of vehicles in each of the categories.

FIG. 2A illustrates an example vehicle selection interface, in accordance with some embodiments. The vehicle selection interface may include vehicle user interface elements 200 for vehicles that a user can select using the vehicle selection interface. Each vehicle user interface element may include the make, model and year of the vehicle, the price of the vehicle, and the mileage of the vehicle.

The vehicle selection interface additionally may include a vehicle availability element 210. The vehicle availability element 210 illustrated in FIG. 2A is a horizontal histogram, though the vehicle availability element 210 may include a vertical histogram in alternative embodiments. Similarly, the vehicle availability element 210 may not include a histogram, and include some other representation of the availability of vehicles in a set of categories. The vehicle availability element 210 may display a set of categories 220 and indicate the availability 230 of vehicles in each category 220. For example, the vehicle availability element 210 illustrated in FIG. 2A indicates the availability 230 of vehicles within certain price range categories 220. However, alternative embodiments of the vehicle availability element 210 may indicate the availability 230 of vehicles in other categories, such as mileage, year, or make. In some embodiments, the vehicle availability element 210 illustrates the availability 230 of vehicles in multiple sets of categories. For example, the vehicle availability element 210 may represent the availability of vehicles within different price ranges and within different mileage ranges. The vehicle availability element 210 may display the availability 230 of vehicles based on sensor data describing measurements of vehicles available on the online system 120. For example, the displayed vehicle availabilities 210 may reflect whether the online system 120 has predicted that a user intends to select a vehicle because the online system 120 has detected that the vehicle has been unlocked or is being driven.

The availability determination module 140 determines the availability of vehicles within categories. The availability of vehicles within a category represents a likelihood that a user will be able to select a vehicle within the category. In some embodiments, the availability of vehicles within a category may simply represent the current inventory of vehicles within the category. The availability determination module 140 may continually determine the current inventory of vehicles within categories based on vehicle purchase information, vehicle selection information, and vehicle maintenance information.

In some embodiments, the availability determination module 140 generates an availability score for each of a set of categories, where each availability score represents an availability of vehicles within each category. The availability determination module 140 may generate an availability score based on the current inventory of vehicles within a category. Additionally, the availability determination module 140 may generate the availability score based on inventory trends for vehicles within the category. For example, the availability determination module 140 may generate an availability score based on a rate at which the online system 120 is acquiring new vehicles and/or a rate at which vehicles within the category are being selected. In some embodiments, the availability determination module 140 generates availability scores based on inventory trends within some time period before the availability scores are generated. For example, the availability determination module 140 may generate availability scores based on inventory trends within the last 90 days.

In some embodiments, the availability determination module 140 generates availability scores based on a machine-learning model (e.g., a neural network) that is trained to generate availability scores based on availability data. Availability data is data that describes factors that could impact the availability of vehicles within a category. For example, availability data may include data describing vehicle purchases by the online system 120, data describing vehicle selections by users of the online system 120, web traffic data describing user interactions with a website offered by the online system 120, and/or application traffic data describing user interactions with an application offered by the online system 120. In some embodiments, the availability determination module 140 receives availability data from the user device 100 and/or from third-party entities.

In some embodiments, the availability determination module 140 updates availabilities illustrated in a vehicle selection interface based on newly received availability data. For example, the availability determination module 140 may receive sensor data describing sensor measurements of a vehicle available for selection on the online system 120 and may update the vehicle availability element to indicate another user's interest in the vehicle based on the sensor data. Similarly, the availability determination module 140 may receive selection data describing vehicle selections from users of the online system 120 and may indicate a decreased availability of vehicles based on an increase in selections by users of the online system 120.

FIG. 2B illustrates an example vehicle selection interface with updated availabilities, in accordance with some embodiments. For example, the vehicle availability element illustrated in FIG. 2B predicts a decrease 240 in availability for vehicles in the $15,000-$20,000 price category. The vehicle availability element may predict a decrease 240 because the online system 120 has received sensor data indicating that one or more vehicles within that price category are being test driven by one or more users, and thereby has predicted that there is a likelihood that users will select those vehicles. Similarly, the vehicle availability element predicts an increase 250 in availability for vehicles in the $30,000-$35,000 price category.

In some embodiments, the availability determination module 140 updates the vehicle availability element based on user interest in individual vehicles offered for selection on the online system 120. For example, the availability determination module 140 may receive information indicating that a user has requested a price quote for a vehicle within a category. Responsive to receiving that information about that price quote, the availability determination module 140 may update a vehicle availability element presented to another user of the online system 120 to indicate a decreased availability of vehicles in the category of the vehicle for which the user requested a price quote. Similarly, the availability determination module 140 may receive a selection by a user of a vehicle user interface element presented on a vehicle selection interface. The availability determination module 140 may indicate, in a vehicle selection interface presented to another user, a decreased availability for vehicles in the category of the selected vehicle in response to receiving the selection from the user.

In some embodiments, the availability determination module 140 updates the vehicle availability element based on data received from a third-party entity that uses the online system 120 to provide vehicles for selection by users. For example, the availability determination module 140 may receive data from sales software used by a third-party vehicle dealership that indicates customer interest in vehicles offered by the dealership. The dealership may offer a vehicle both on site and through the online system 120. The data may describe a salesperson at the dealership presenting information about a particular vehicle to a customer. For example, if the salesperson uses a client device 100 to display information about a vehicle to customers, the client device 100 may transmit data describing which vehicles the salesperson is showing to the customer. Similarly, if the dealership uses a centralized system for providing vehicle information to devices used by salespersons, the availability determination module 140 may receive data from the centralized system describing vehicles for which the salespersons have requested information.

In some embodiments, the availability determination module 140 updates the vehicle availability element based on vehicle access information received. Vehicle access information is information describing when a person accesses a vehicle. For example, vehicle access information may describe the vehicle locking or unlocking, a vehicle door opening, a vehicle trunk opening, and/or a vehicle hood opening. The availability determination module 140 may update the vehicle availability element based on vehicle access information. For example, responsive to the availability determination module 140 receiving information indicating that a vehicle has been accessed, the availability determination module 140 may update a vehicle availability element to indicate a decreased availability in a category of the accessed vehicle.

In some embodiments, the availability determination module 140 applies one or more heuristics to the vehicle access information to determine possible changes to vehicle availability based on user interest in a vehicle. The availability determination module 140 may weight different types of vehicle accesses based on their likelihood to indicate that a user is interested in the vehicle. For example, the availability determination module 140 may apply a lower weight to a door opening or the vehicle locking and may apply a higher weight to a vehicle hood opening. In some embodiments, the availability determination module 140 applies a machine-learning model to vehicle access information to determine possible changes to vehicle availability based on user interest in a vehicle. The machine-learning model may be trained to predict changes to vehicle availability in categories based on vehicle access information. For example, the machine-learning model may be trained based on training data where vehicle access information is labeled with whether a user selected the vehicle associated with the vehicle access information.

In some embodiments, vehicle access information includes information from a lock interface system that stores keys for vehicles. A lock interface system may store keys for vehicles and control access to the keys by users of the lock interface system. For example, the lock interface system may require a salesperson to identify themselves through a client device 100 to access a key and may store information describing which salesperson accessed which key for which vehicle. The lock interface system may transmit this information to the availability determination module 140, and the availability determination module 140 may use this information to update the availabilities of vehicles in the vehicle availability element. For example, responsive to the availability determination module 140 receiving information indicating that a vehicle's key has been accessed from the lock interface system, the availability determination module 140 may determine that a user is likely to take the vehicle on a test drive. The availability determination module 140 may then update a vehicle availability element to indicate a decreased availability in a category of the vehicle associated with the accessed key because a user is more likely to select the vehicle. In some embodiments, the availability determination module 140 applies a machine-learning model to vehicle access information that includes information from a lock interface system to predict a likelihood that a user will select the vehicle based on the vehicle access information. For example, the availability determination module 140 may determine that a user is likely to select the vehicle if the user opened the hood of the vehicle before taking the vehicle on a test drive. In some embodiments, the availability determination module 140 applies one or more heuristics to determine whether a user is likely to select a vehicle after taking the vehicle on a test drive.

In some embodiments, the availability determination module 140 updates a vehicle availability element based on sensor data received from a vehicle. Sensor data is data captured by a sensor of a vehicle describing operation of the vehicle. For example, the sensor data may describe acceleration of a vehicle, the braking of a vehicle, a vehicle locking or unlocking, a location of the vehicle, and/or the steering of a vehicle. The availability determination module 140 may determine that a user is interested in a vehicle based on sensor data and may update a vehicle availability element. For example, responsive to the availability determination module 140 receiving sensor data indicating that a vehicle is being accelerated, the availability determination module 140 may determine that a user is test driving the vehicle and is therefore interested in the vehicle. Accordingly, the availability determination module 140 may update a vehicle availability element to indicate a decreased availability in a category of the vehicle. In some embodiments, the availability determination module 140 applies a machine-learning model to sensor data to predict a likelihood that a user will select the vehicle based on the sensor data. For example, if the availability determination module 140 detects that a vehicle has been driven off of a dealership lot, the availability determination module 140 may determine that the vehicle is likely being test driven and therefore is more likely to be selected by a user.

In some embodiments, the availability determination module 140 determines whether a vehicle is being test driven based on location data received from a location sensor of the vehicle and whether a route taken by a vehicle is similar to other test drives vehicles have taken. The availability determination module 140 may receive location sensor data from a location sensor in a vehicle describing a route taken by the vehicle. The availability determination module 140 may compare the route with common test-driving routes taken by vehicles in the past. In some embodiments, the availability determination module 140 applies a machine-learning model trained to compare routes taken by a vehicle with common test-driving routes to predict a likelihood that the vehicle's route is a test-driving route. Responsive to the route being sufficiently similar to common test-driving routes, the availability determination module 140 may determine that the vehicle is being test driven. The availability determination module 140 may then update a vehicle availability element to indicate a decreased availability in a category of the test-driven vehicle because a user is more likely to select the vehicle after having test driven the vehicle.

In some embodiments, the availability determination module 140 indicates another user's interest in a vehicle by indicating the other user's interest in a vehicle user interface element. FIG. 2C illustrates an example vehicle selection interface with a vehicle user interface element with an indication 260 of another user's interest in the vehicle associated with the vehicle user interface element, in accordance with some embodiments. In FIG. 2C, the indication 260 may be that the online system 120 has received sensor data indicating that one or more vehicles within that price category are being test driven by one or more users. However, the indication 260 may illustrate other methods by which another user may have expressed interest in the vehicle. For example, the indication 260 may indicate that another user has asked for a quote for the vehicle, accessed the vehicle, viewed the vehicle via another vehicle selection interface, and/or been displayed information about the vehicle by a salesperson in a dealership. In some embodiments, the indication 260 simply indicates that another user may be interested in the vehicle without stating how the other user has expressed that interest.

In some embodiments, the availability determination module 140 indicates another user's interest in a vehicle within a category through the vehicle availability element. FIG. 2D illustrates a vehicle selection interface with a vehicle availability element showing an indication 270 of another user's interest in a vehicle within a category, in accordance with some embodiments. The indication 270 illustrated in FIG. 2D indicates a number of users interested in vehicles in the $15,000-$20,000 price category. For example, the online system 120 may have received sensor data indicating that 10 vehicles within that price category are being test driven by 10 users, and thereby has predicted that there is a likelihood that users will select those vehicles. However, in alternative embodiments, the indication 270 may simply indicate that other users are interested in vehicles in the category without specifying a number of users interested in vehicles in the category. The indication 270 may indicate the manner by which users have expressed interest in vehicles in the category. For example, the indication 270 may indicate that users have asked for quotes for vehicles, test driving vehicles, accessed vehicles, or been displayed information about vehicles by a salesperson in a dealership.

The vehicle selection module 150 receives a user selection from the vehicle selection interface and assigns the vehicle to the user. For example, responsive to the user selecting a vehicle for purchase, the vehicle selection module 150 may request payment information from the user and transfer title of the vehicle to the user. Similarly, responsive to the user selecting a vehicle for rent, the vehicle selection module 150 may request rental information from the user (e.g., the term of the rental, payment information, pickup and drop-off locations for the vehicle) and may provide the user with information for the user to receive the rented vehicle. In some embodiments, the vehicle selection module 150 coordinates with one or more vehicle dealerships and/or vehicle rental services to provide selected vehicles to a user. These vehicle dealerships and vehicle rental services may be part of the online system 120 or may be third parties who use the online system 120 to provide vehicle selection services to users of the online system 120.

The data store 160 stores data used by the online system 120 to provide vehicle selection interfaces to users through client devices 100. For example, the data store 160 may store data describing vehicles that are available for selection on the online system 120. For example, the data store 160 may store make, model, year, mileage, or price information for each vehicle available on the online system 120. The data store 160 additionally may store inventory data describing how many vehicles in a particular category the online system 120 has available for selection and/or describing purchase and/or sales information for vehicles in a category. In some embodiments, the data store 160 stores information describing a user of the online system 120, such as the user's name, location, or payment information. The data store 160 may receive data from client devices 100 or from third-party systems. In some embodiments, the data store 160 receives data from centralized systems of vehicle dealerships or vehicle rental companies.

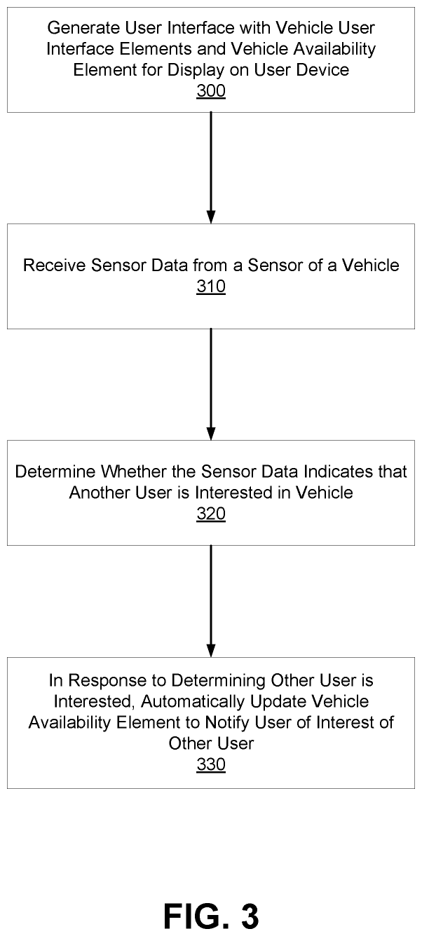

FIG. 3 is a flowchart for a method of determining vehicle availability for an online system, in accordance with some embodiments. Alternative embodiments may include more, fewer, or different steps from those illustrated in FIG. 3, and the steps may be performed in a different order from that illustrated in FIG. 3. Additionally, each of these steps may be performed automatically by the online system without human intervention.

The online system generates 300 a user interface for display on a user device of a user. The user interface may be a vehicle selection interface. The user interface may include a set of vehicle user interface elements for a set of vehicles offered for selection by the online system. The user interface may further include a vehicle availability element describing availabilities of vehicles in each of a set of vehicle categories. For example, the vehicle availability element may describe an availability of vehicles in each of a set of price ranges. In some embodiments, the vehicle availability element includes a histogram describing availability of vehicles in a set of categories.

The online system may update the vehicle availability element based on user interest in vehicles within each category. For example, the online system may receive 310 sensor data from a vehicle offered for selection by the online system. The online system may determine 320 whether a user is interested in the vehicle based on the received sensor data. For example, the sensor data may include data indicating that the vehicle has been unlocked or may include data indicating a location or movement of the vehicle. Responsive to the online system determining that a user is interested in the vehicle, the online system may automatically update 330 the vehicle availability element to notify the user of the interest in the vehicle of the other user.

### Additional Considerations

As described above, the online system described herein improves on conventional user interface technology by ensuring that the online system does not present out-of-date or incorrect information. The online system described herein may solve this problem by considering sensor data from vehicles available on the online system to determine whether a user is expressing interest in the vehicle, e.g., by taking the vehicle for a test drive. Thus, the online system herein provides more accurate and up-to-date information to a user.

The foregoing description of the embodiments has been presented for the purpose of illustration; it is not intended to be exhaustive or to limit the patent rights to the precise pages disclosed. Persons skilled in the relevant art can appreciate that many modifications and variations are possible in light of the above disclosure. For example, the foregoing description primarily describes the online system in the context of vehicle selection, such as the selection of automobiles, trucks, motorcycles, boats, scooters, bicycles, and/or golf carts. An online system may use a selection interface such as the one described herein for the selection of many kinds of products or services that may be made available to a user.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some embodiments, a software module is implemented with a computer program product comprising one or more computer-readable media containing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to an apparatus for performing the operations herein. This apparatus may be specially constructed for the required purposes, or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C having at least one element in the combination being true (or present). As a not-limiting example, the condition “A, B, or C” is satisfied by A and B are true (or present) and C is false (or not present). Similarly, as another not-limiting example, the condition “A, B, or C” is satisfied by A is true (or present) and B and C are false (or not present).

1. A method of indicating user interest in a vehicle on a user interface of an online system, the method comprising:
generating, by an online system, a user interface for display on a user device of a first user, wherein the user interface comprises a set of vehicle user interface elements for a set of vehicles and a vehicle availability element describing an availability of vehicles in each of a set of categories;
receiving, by the online system, sensor data from a sensor of a vehicle of the set of vehicles, the sensor data describing one or more measurements of activity of the vehicle taken by the sensor;
in response to receiving the sensor data, determining, by the online system, that the one or more measurements of the activity of the vehicle indicates that a second user is interested in the vehicle;
in response to determining that the second user is interested in the vehicle, automatically identifying a category of the set of categories to which the vehicle corresponds; and
updating a portion of the vehicle availability element associated with the identified category to notify the first user of the interest of the second user.

2. The method of claim 1, wherein automatically updating the vehicle availability element comprises:
identifying a price of the vehicle on the online system; and
updating a portion of the vehicle availability element associated with the identified price to notify the first user of the interest of the second user in a vehicle at the identified price.

3. The method of claim 1, further comprising:
receiving a user interaction by the first user with a slider user interface element associated with the vehicle availability element, wherein the user interaction with the slider user interface element indicates a maximum price that the first user wants to pay for a vehicle; and
responsive to receiving the user interaction, automatically updating the user interface by removing one or more of the set of user interface elements based on the indicated maximum price.

4. The method of claim 1, further comprising
determining a vehicle availability trend based on inventory data, sales data, and user data, wherein the vehicle availability trend describes a predicted change in availability of vehicles at a price; and
automatically updating the vehicle availability element to notify the first user of the vehicle availability trend.

5. The method of claim 4, wherein the vehicle availability trend is determined based on an increase in sales of vehicles available at the price.

6. The method of claim 4, wherein the vehicle availability trend is determined based on an increase in users of the online system viewing vehicles available at the price.

7. The method of claim 1, further comprising:
receiving a notification from a user device of a third user that the second user is interested in the vehicle; and
in response to receiving the notification, automatically updating the vehicle availability element to notify the first user of the interest of the second user.

8. The method of claim 1, wherein the sensor data comprises data indicating that the vehicle has been unlocked.

9. The method of claim 1, wherein the sensor data comprises data indicating a location or a movement of the vehicle.

10. The method of claim 9, wherein determining whether the sensor data indicates that a user is interested in the vehicle comprises determining, based on the sensor data, whether the vehicle is traveling along a test drive route.

11. The method of claim 1, wherein the vehicle availability element displays the availability of vehicles in each category in a set of categories in visual association with the category of the set of categories.

12. A non-transitory computer-readable medium storing instructions that, when executed by one or more processors, causes the one or more processors to perform steps for indicating user interest in a vehicle on a user interface of an online system, wherein the instructions cause the one or more processors to:
generate by an online system, a user interface for display on a user device of a first user, wherein the user interface comprises a set of vehicle user interface elements for a set of vehicles and a vehicle availability element describing an availability of vehicles in each of a set of categories;
receive, by the online system, sensor data from a sensor of a vehicle of the set of vehicles, the sensor data describing one or more measurements of activity of the vehicle taken by the sensor;
in response to receiving the sensor data, determine, by the online system, that the one or more measurements of the activity of the vehicle indicates that a second user is interested in the vehicle;
in response to determining that the second user is interested in the vehicle, automatically identifying a category of the set of categories to which the vehicle corresponds; and
update a portion of the vehicle availability element associated with the identified category to notify the first user of the interest of the second user.

13. The computer-readable medium of claim 12, wherein automatically updating the vehicle availability element comprises:
identifying a price of the vehicle on the online system; and
updating a portion of the vehicle availability element associated with the identified price to notify the first user of the interest of the second user in a vehicle at the identified price.

14. The computer-readable medium of claim 12, wherein the instructions further cause the processor to:
receive a user interaction by the first user with a slider user interface element associated with the vehicle availability element, wherein the user interaction with the slider user interface element indicates a maximum price that the first user wants to pay for a vehicle; and
responsive to receiving the user interaction, automatically update the user interface by removing one or more of the set of user interface elements based on the indicated maximum price.

15. The computer-readable medium of claim 12, wherein the instructions further cause the processor to:
determine a vehicle availability trend based on inventory data, sales data, and user data, wherein the vehicle availability trend describes a predicted change in availability of vehicles at a price; and
automatically update the vehicle availability element to notify the first user of the vehicle availability trend.

16. The computer-readable medium of claim 15, wherein the vehicle availability trend is determined based on an increase in sales of vehicles available at the price.

17. The computer-readable medium of claim 15, wherein the vehicle availability trend is determined based on an increase in users of the online system viewing vehicles available at the price.

18. The computer-readable medium of claim 12, wherein the instructions further cause the processor to:
receive a notification from a user device of a third user that the second user is interested in the vehicle; and
in response to receiving the notification, automatically update the vehicle availability element to notify the first user of the interest of the second user.

19. The computer-readable medium of claim 12, wherein the sensor data comprises data indicating a location or a movement of the vehicle.

20. The computer-readable medium of claim 19, wherein determining whether the sensor data indicates that a user is interested in the vehicle comprises determining, based on the sensor data, whether the vehicle is traveling along a test drive route.
